(19) United States
(12) Patent Application Publication
(10) Pub. No.: US 2025/0251594 A1
(43) Pub. Date: Aug. 7, 2025

(54) NEAR-EYE DISPLAY WAVEGUIDE DEVICE AND NEAR-EYE DISPLAY APPARATUS

(71) Applicant: JIAXING UPHOTON OPTOELECTRONICS TECHNOLOGY CO., LTD., Jiaxing City (CN)

(72) Inventors: Zhentao FAN, Jiaxing City (CN); Lei Sui, Jiaxing City (CN); Kehan Tian, Jiaxing City (CN)

(21) Appl. No.: 19/045,050

(22) Filed: Feb. 4, 2025

(30) Foreign Application Priority Data
Feb. 5, 2024 (CN) 202410166431.9

(51) Int. Cl. G02B 27/01; G02B 5/18

(52) U.S. Cl. CPC G02B 27/0101; G02B 5/1866

(57) ABSTRACT

A near-eye display waveguide device and a near-eye display apparatus are disclosed. The waveguide device comprises m waveguide substrates stacked on each other, m being an integer and m≥3. The device receives image-carrying light with an image field of view angle range, and the image-carrying light comprises light with less than m dominant wavelengths. Corresponding to each dominant wavelength, the m waveguide substrates are formed with at least two coupling-in gratings, the at least two coupling-in gratings are formed on different substrates and have different grating periods, for coupling light in different coupling-in field of view angle ranges into corresponding substrates, the coupling-in field of view angle ranges are each smaller than the image field of view angle range, and the coupling-in field of view angle ranges cover the image field of view angle range as a whole.

### TECHNICAL FIELD

The present disclosure relates to near-eye display technology, particularly a near-eye display waveguide device and a near-eye display apparatus having the waveguide device.

### BACKGROUND

With the development of science and technology, AR (Augmented Reality) display technology is slowly becoming popular as a brilliant and portable display technology. Its main feature is to superimpose virtual images on real scenes, allowing people to watch virtual images while also watching real scenes. Diffractive optical waveguide devices have been widely used in AR displays. Diffractive optical waveguides have the advantages of being light, thin, having strong pupil expansion ability, and easy mass production, and they have become the core components of AR display devices.

With the gradual development of diffractive optical waveguide technology, people have put forward higher and higher requirements for its color uniformity and field of view. In order to expand the field of view and achieve full color, people have proposed a solution of using three waveguide substrates, as shown in FIG. 1, in which three waveguide substrates Wr, Wg, and Wb are used for displaying images of red, green, and blue colors, respectively, and each of the waveguide substrates Wr, Wg, and Wb is formed with a coupling-in grating 1 for coupling light of the corresponding color into the waveguide substrate and a coupling-out grating 2 for expanding the pupil and coupling the light out of the waveguide substrate to achieve image display; the light of different colors overlap on each other after being coupled out by the coupling-out grating 2, so that the human eye E can observe a color image. However, in the existing technical solutions, the colors between different waveguide substrates are often prone to crosstalk, resulting in poor color uniformity. In addition, the field of view that can be displayed is limited by the refractive index of the waveguide substrate and the grating parameters of the coupling-in grating and the coupling-out grating formed thereon, which cannot meet the increasing display needs.

### SUMMARY

The object of the present disclosure is to provide a near-eye display waveguide device and a near-eye display apparatus having the waveguide device, which at least partially overcome the above-mentioned problems in the prior art.

According to one aspect of the present disclosure, a near-eye display waveguide device is provided, which comprises m waveguide substrates stacked on each other, m is an integer and m>3, the near-eye display waveguide device receiving image-carrying light with an image field of view angle range, and the image-carrying light comprising light of less than m dominant wavelengths, wherein:
corresponding to each dominant wavelength, the m waveguide substrates are formed with at least two coupling-in gratings, the at least two coupling-in gratings are formed on different waveguide substrates and have different grating periods, for being used to couple light in different coupling-in field of view angle ranges into corresponding waveguide substrates, wherein the coupling-in field of view angle ranges are each smaller than the image field of view angle range, and the coupling-in field of view angle range as a whole covers the image field of view angle range.

Advantageously, each waveguide substrate is formed with a coupling-out grating and at least one coupling-in grating; after being coupled into a waveguide substrate through a corresponding coupling-in grating, the image-carrying light of each dominant wavelength propagates to the coupling-out grating of the waveguide substrate through a total reflection path corresponding to the coupling-in grating; and a total reflection path corresponding to a coupling-in grating for coupling light of one dominant wavelength does not pass through a coupling-in grating for coupling light of another dominant wavelength.

Advantageously, the coupling-in gratings formed on the m waveguide substrates have the same grating vector direction; and the coupling-in gratings formed on the m waveguide substrates for coupling light of different dominant wavelengths are separated from each other in a direction parallel to each waveguide substrate and perpendicular to the grating vector direction.

Advantageously, the coupling-in gratings formed on the same waveguide substrate have the same grating vector direction and grating period and are arranged at substantially the same orientation relative to the coupling-out gratings on the waveguide substrate; or

the coupling-in gratings formed on the same waveguide substrate have different grating vector directions and/or grating periods and are arranged at different orientations relative to the coupling-out gratings on the waveguide substrate.

Advantageously, the coupling-in gratings formed on the same waveguide substrate for coupling light of different dominant wavelengths have different grating structure features, and the grating structure features comprise one or more of depth, height, duty cycle, blaze angle, and optical coating of the gratings.

Advantageously, the projections of at least two coupling-in gratings formed on different waveguide substrates for coupling light of the same dominant wavelength overlap each other in a direction perpendicular to the waveguide substrate.

Advantageously, at least two coupling-in gratings are formed on adjacent waveguide substrates.

Advantageously, the m waveguide substrates are waveguide substrates Wᵢ, i is an integer and 1≤i≤m, wherein,
for i=1, a coupling-in grating G_{(1,1)} for a dominant wavelength λ₁ is formed on a waveguide substrate W₁, and a coupling-in grating G_{(1,1)} has a grating period d₁;
for i=m, a coupling-in grating G_{(m-1,2)} for a dominant wavelength λₘ₋₁ is formed on a waveguide substrate Wₘ, and the coupling-in grating G_{(m-1,2)} has a grating period dₘ;
for 2≤i≤m−1, a coupling-in grating G_{(i,1)} for a dominant wavelength λᵢ and a coupling-in grating G_{(i-1,2)} for the dominant wavelength λᵢ₋₁ are formed on the waveguide substrate Wᵢ, and satisfy: λᵢ₋₁>λᵢ>λᵢ₊₁.

Advantageously, for 2≤i≤m−1, the coupling-in grating G_{(i,1)} and the coupling-in grating G_{(i-1,2)} have the same grating vector direction and grating period dᵢ, and dᵢ₋₁>dᵢ>dᵢ₊₁.

Advantageously, m=4, and the image-carrying light comprises red, green, and blue light.

Advantageously, the m waveguide substrates are made of materials with the same or similar refractive index.

Advantageously, for 1≤i≤m−1: λᵢ/dᵢ is approximately a constant C₁, and/or λᵢ/dᵢ₊₁ is approximately a constant C₂, wherein a deviation is within ±5%.

Advantageously, for 2≤i≤m−1, the coupling-in grating G_{(i,1)} and the coupling-in grating G_{(i-1,2)} have different grating structure features, and the grating structure features comprise one or more of depth, height, duty cycle, blaze angle and optical coating of the gratings.

Advantageously, for 1≤i≤m−1, j is an integer and 1≤j≤m−1, k=1 or 2, and i≠j, a coupling-in grating G_{(i,k)} and a coupling-in grating G_{(j,k)} are separated from each other in a direction perpendicular to the waveguide substrates.

Advantageously, for 1≤i≤m−1, the projections of the coupling-in grating G_{(i,1)} and the coupling-in grating G_{(i,2)} overlap each other in a direction perpendicular to the waveguide substrates.

Advantageously, the coupling-in grating G_{(i,1)} and the coupling-in grating G_{(i,2)} are formed on adjacent waveguide substrates.

According to another aspect of the present disclosure, a near-eye display apparatus is provided, comprising the near-eye display waveguide device as described above.

Advantageously, the near-eye display apparatus further comprises a lens and a frame for holding the lens close to the eye, and the lens comprises the near-eye display waveguide device.

In the near-eye display waveguide device according to embodiments of the present disclosure, corresponding to each dominant wavelength, at least two coupling-in gratings with different grating periods formed on different waveguide substrates are provided to couple light in different coupling-in field of view angle ranges into the corresponding waveguide substrate for image display, thereby expanding the field of view angle range of the near-eye display as a whole.

In addition, according to the embodiment of the present disclosure, by designing the relative position relationship of the coupling-in gratings for different dominant wavelengths in the projection in the direction perpendicular to the waveguide substrate, color crosstalk can be avoided and color uniformity can be improved.

### BRIEF DESCRIPTION OF THE DRAWINGS

Other features, objects, and advantages of the present disclosure will become more apparent by reading the following detailed description of non-limitative embodiments with reference to the following drawings.

FIG. 1 is a schematic diagram of a waveguide device for realizing full-color display in the prior art;

FIG. 2 is a wave vector space graph of a waveguide device for realizing full-color display based on a single waveguide substrate and a wave vector space graph of the waveguide device shown in FIG. 1;

FIG. 3 is a side view of an example of a near-eye display waveguide device according to embodiments of the present disclosure;

FIG. 4 is a top view and another side view of the near-eye display waveguide device shown in FIG. 3, schematically showing an arrangement of coupling-in gratings;

FIG. 5 schematically shows an exemplary relationship between the coupling-in field of view angle ranges of two coupling-in gratings for the same dominant wavelength in a near-eye display waveguide device according to some embodiments of the present disclosure and the image field of view angle range of the image-carrying light projected by a light engin;

FIG. 6 is a wave vector space graph of a near-eye display waveguide device according to some embodiments of the present disclosure;

FIG. 7 schematically shows an example of a grating structure of each coupling-in grating of the near-eye display device shown in FIG. 3 and FIG. 4.

FIG. 8 schematically shows another example of a near-eye display waveguide device according to embodiments of the present disclosure and the arrangement of its coupling-in gratings;

FIG. 9 schematically shows an exemplary relationship between the coupling-in field of view angle range of three coupling-in gratings for the same dominant wavelength in a near-eye display waveguide device according to other embodiments of the present disclosure and the image field of view angle range of the image-carrying light projected by a light engin;

FIG. 10 is a top view of another example of a near-eye display waveguide device according to embodiments of the present disclosure;

FIG. 11 schematically shows an arrangement of coupling-in gratings in the near-eye display waveguide device shown in FIG. 10; and

FIG. 12 is a top view of another example of a near-eye display waveguide device according to embodiments of the present disclosure, showing an arrangement of coupling-in gratings relative to coupling-out gratings.

### DETAILED DESCRIPTION

The present disclosure will be further described in detail in conjunction with drawings and embodiments. It should be understood that the specific embodiments described herein are only used to explain the related disclosure, but not to limit the disclosure. For the convenience of description, only the parts related to the disclosure are shown in the drawings. It should be noted that the embodiments in the present application and the features of the embodiments can be combined with each other without conflict.

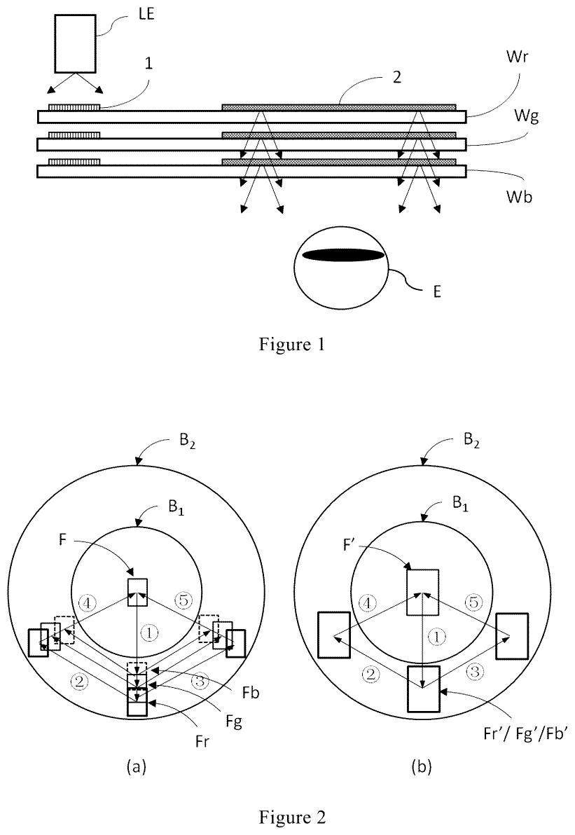

In order to better illustrate the inventive concept of the present disclosure, firstly, referring to FIG. 2, the field of view angle range that can be supported by the diffractive optical waveguide is analyzed by analyzing light beam wave vector space.

Graph (a) in FIG. 2 shows a wave vector space graph of a waveguide device that realizes full-color display based on a single waveguide substrate in the prior art, and Graph (b) in FIG. 2 shows a wave vector space graph of a waveguide device of FIG. 1 that realizes full-color display based on three waveguide substrates corresponding to three colors of red, green and blue.

In the wave vector space shown in FIG. 2, B₁ represents a first wave vector boundary formed by satisfying the total internal reflection condition in the waveguide device, and the first wave vector boundary B₁ can be normalized to a circle with a radius of 1; and B₂ represents a second wave vector boundary corresponding to a maximum wave vector that can be transmitted in the waveguide device, and the second wave vector boundary B₂ is determined by the refractive index of the waveguide substrate. Light beam can be transmitted in the waveguide device only when a light beam wave vector is in an annular space between the first wave vector boundary B₁ and the second wave vector boundary B₂. If the light beam wave vector is within the first wave vector boundary B₁, the light will leak out of the waveguide substrate; and if the light beam wave vector is outside the second wave vector boundary B₂, the diffraction order does not exist and the corresponding image-carrying light cannot be transmitted.

FIG. 2 shows angle spectra F and F′ of the image-carrying light, the coupling-in effect of the coupling-in grating on the light beam (see the mark “\textcircled{1}” in FIG. 2), the pupil expansion effect of the waveguide device on the light beam (see the marks “\textcircled{2}” and “\textcircled{3}” in FIG. 2), and the coupling-out effect of the coupling-out grating on the light beam (see the marks “\textcircled{4}” and “\textcircled{5}” in FIG. 2), and also shows the angle spectrum range (corresponding to the field of view angle range) Fr, Fg, Fb and Fr′, Fg′, Fb′ of the light beam that the waveguide device can transmit.

As shown in Graph (a) of FIG. 2, for example, for a full-color light beam comprising red, green, and blue light, due to the dispersion effect of the coupling-in grating, the angle spectra (corresponding to the field of view angle range) Fr, Fg, Fb of the red, green and blue light beams are offset in the available annular space between the first boundary BI and the second boundary B₂. This dispersion effect results in the angle spectra Fr, Fg, Fb of the full-color light beam that can be transmitted by the waveguide substrate in the waveguide device that realizes full-color display based on the single waveguide substrate (see Graph (a) in FIG. 2) to be significantly smaller than the angle spectra Fr′, Fg′, Fb′ of the monochromatic light beam that can be transmitted by each waveguide substrate in the waveguide device that realizes full-color display based on three waveguide substrates corresponding to the three colors of red, green and blue (see Graph (b) in FIG. 2).

The width of the annular space between the first boundary B₁ and the second boundary B₂ in the wave vector space shown in FIG. 2 is mainly determined and limited by the refractive index of the waveguide substrate, and the angle spectrum range (corresponding to the field of view angle range) of the light beam that the waveguide device can support for transmission is limited by the width of the annular space. For example, roughly calculated, a single glass substrate with a refractive index of 1.9 only supports full-color light beam transmission with a 30° diagonal field of view, and when three glass substrates with a refractive index of 1.9 are used to realize the display of red, green, and blue colors respectively, it yet only supports a 65° diagonal field of view; a single glass substrate with a refractive index of 1.7 only supports full-color light beam transmission with a 20° diagonal field of view, and when three glass substrates with a refractive index of 1.7 are used to realize the display of red, green, and blue colors respectively, it yet only supports a 42° diagonal field of view.

The present disclosure proposes a near-eye display waveguide device, which comprises m (m≥3) waveguide substrates stacked on each other, the near-eye display waveguide device receiving image-carrying light with an image field of view angle range, the image-carrying light comprising light of several dominant wavelengths, and the number of the dominant wavelengths being less than the number of waveguide substrates, wherein corresponding to each dominant wavelength, at least two coupling-in gratings are formed in the m waveguide substrates, the at least two coupling-in gratings are formed on different waveguide substrates, and have different grating periods, for coupling light in different coupling-in field of view angle ranges into the corresponding waveguide substrates, wherein the coupling-in field of view angle ranges are each smaller than the image field of view angle range, and the coupling-in field of view angle range as a whole covers the image field of view angle range.

In this application, “dominant wavelength” is intended to mean a wavelength range with a certain bandwidth and having a center wavelength with a specific value of the “dominant wavelength”.

The present disclosure is proposed to overcome the limitation of the refractive index of the waveguide substrate on the angle spectrum of the transmitted light beam, and the present disclosure is based on a discovery that the angle spectrum range of the light beam transmitted in different waveguide substrates can be biased by changing the ratio of the wavelength of the light beam to the grating period of the coupling-in grating so that the limitation of the refractive index of the waveguide substrate on the angle spectrum range of the transmitted light beam can be overcome by combining more than two waveguide substrates and making the gratings on different waveguide substrates have different wavelength/period ratios. In the near-eye display waveguide device according to the embodiment of the present invention, each color of light is transmitted through at least two waveguide substrates, and the corresponding coupling-in gratings have different grating periods, thereby greatly improving the field of view angle of the full-color display.

An embodiment of a near-eye display waveguide device according to embodiments of the present invention will be described in detail below with reference to the accompanying drawings.

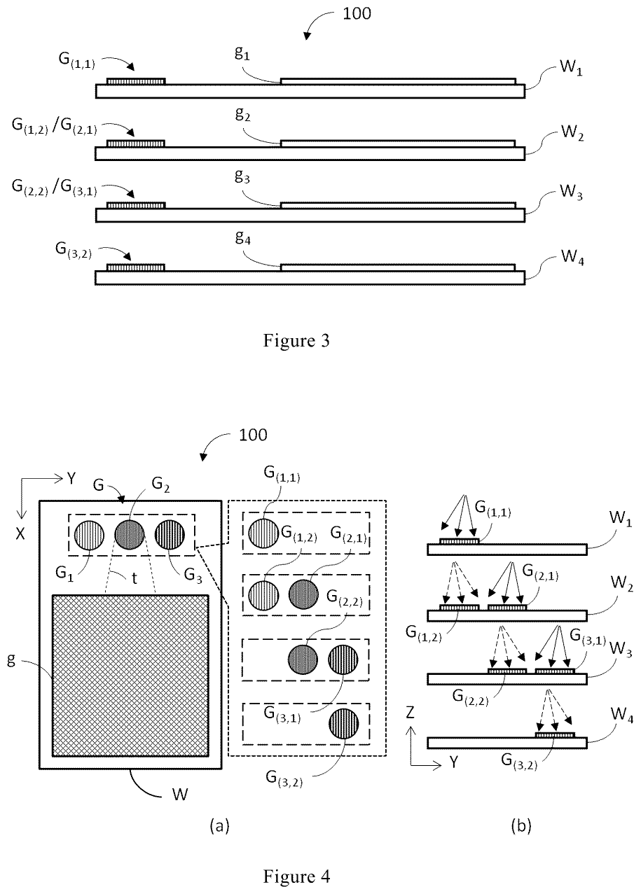

FIG. 3 shows an example of a near-eye display waveguide device according to embodiments of the present invention in a side view, namely, a near-eye display waveguide device 100. In FIG. 4, Graph (a) is a top view of the near-eye display waveguide device 100 observed from a plane perpendicular to a waveguide substrate, and Graph (b) is a side view of the near-eye display waveguide device 100 observed along X direction shown in Graph (a).

In the examples shown in FIG. 3 and FIG. 4, the near-eye display waveguide device 100 is used to receive image-carrying light comprising three dominant wavelengths λ₁, λ₂, and λ₃, and perform near-eye image display. For example, the image-carrying light comprises red light, green light, and blue light. As more clearly shown in FIG. 3, the near-eye display waveguide device 100 comprises four waveguide substrates W₁, W₂, W₃, and W₄ stacked on each other.

According to the embodiment of the present invention, in the near-eye display waveguide device 100, the dominant wavelength λ₁>λ₂>λ₃, and as shown in FIG. 3 and FIG. 4, a coupling-in grating G_{(1,n)} for the dominant wavelength λ₁ is formed on the waveguide substrate W₁; a coupling-in grating G_{(2,1)} for the dominant wavelength λ₂ and a coupling-in grating G_{(1,2)} for the dominant wavelength λ₁ are formed on the waveguide substrate W₂; a coupling-in grating G_{(3,1)} for the dominant wavelength λ₃ and a coupling-in grating G_{(2,2)} for the dominant wavelength λ₂ are formed on the waveguide substrate W₃; and a coupling-in grating G_{(3,2)} for the dominant wavelength λ₃ is formed on the waveguide substrate W₄. These coupling-in gratings are also collectively referred to as “coupling-in gratings G” hereinafter.

According to the embodiment of the present invention, the coupling-in gratings for the same dominant wavelength formed on different waveguide substrates have different grating periods. Therefore, although not shown in FIG. 3 and FIG. 4, the near-eye display waveguide device 100 also has the following features, that is, the coupling-in grating G_{(1,1)} and the coupling-in grating G_{(1,2)} (hereinafter collectively referred to as “coupling-in grating G₁”) for the dominant wavelength λ₁ have different grating periods, the coupling-in grating G_{(2,1)} and the coupling-in grating G_{(2,2)} (hereinafter collectively referred to as “coupling-in grating G₂”) for the dominant wavelength λ₂ have different grating periods, and the coupling-in grating G_{(3,1)} and the coupling-in grating G_{(3,2)} (hereinafter collectively referred to as “coupling-in grating G₃”) for the dominant wavelength λ₃ have different grating periods.

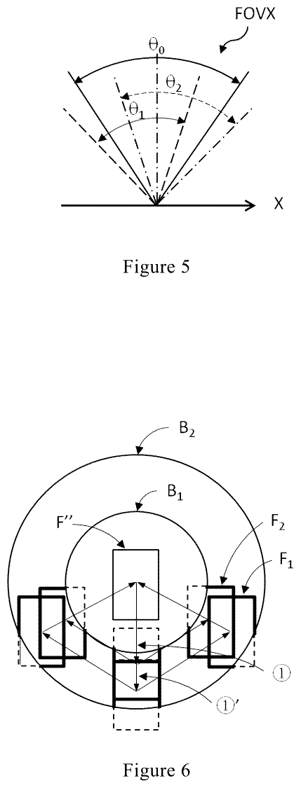

FIG. 5 schematically shows an exemplary relationship between the coupling-in field of view angle range of two coupling-in gratings for the same dominant wavelength in a near-eye display waveguide device according to some embodiments of the present disclosure and the image field of view angle range of the image-carrying light projected by a light engin. The near-eye display waveguide device 100 shown in FIGS. 3 and 4 is configured such that the coupling-in field of view angle ranges θ₁ and θ₂ of two coupling-in gratings (such as coupling-in gratings G_{(1,n)} and G_{(1,2)} for the same dominant wavelength and the image field of view angle range θ₀ of the image-carrying light projected by the light engin conform to the relationship schematically shown in FIG. 5, that is, the coupling-in field of view angle ranges θ₁ and θ₂ are each smaller than the image field of view angle range θ₀, but cover the image field of view angle range θ₀ as a whole.

It can be seen that the near-eye display waveguide device 100 adopts a 4-piece waveguide substrate configuration, and the configuration of the coupling-in gratings allows each color of light to be transmitted through two waveguide substrates, and the corresponding coupling-in gratings have different grating periods so that the coupling-in field of view angle ranges θ₁ and θ₂ are offset relative to each other, thereby achieving a larger coverage of the image field of view angle range θ₀.

In order to better illustrate the technical advantages of the near-eye display waveguide device according to the embodiment of the present disclosure in expanding the field of view angle range, FIG. 6 further shows a wave vector space graph of a near-eye display waveguide device according to some embodiments of the present disclosure. For clarity, FIG. 6 only shows a wave vector space graph for a light beam of a single dominant wavelength.

Taking the near-eye display waveguide device 100 and the dominant wavelength λ₁ as an example, FIG. 6 shows an angle spectrum F″ of the image-carrying light, shows coupling-in, pupil expansion and coupling-out effects of the coupling-in grating G_{(1,1)} on the light beam (the mark “\textcircled{1}” in FIG. 6 represents the coupling-in effect of the coupling-in grating G_{(1,1)} on the light beam, and the mark “\textcircled{1}′” represents the coupling-in effect of the coupling-in grating G_{(1,2)} on the light beam), and also shows the angle spectrum range of the light beam that can be transmitted by the waveguide device (corresponding to the field of view angle range) F₁, F₂. It can be seen that although the coupling-in grating G_{(1,1)} and the coupling-in grating G_{(1,2)} can not completely couple the image-carrying light with the angle spectrum F″ into the corresponding waveguide substrates W₁, W₂, the angle spectra F₁ and F₂ of the image-carrying light that they can couple can “piece together” the complete angle spectrum F. That is to say, the coupling-in gratings G_{(1,1)} and the coupling-in gratings G_{(1,2)} respectively formed on the waveguide substrates Wᵢ and W₂ can realize image display in the field of view angle range corresponding to the angle spectrum F″. Comparing the wave vector space graph shown in FIG. 2, it can be seen that the near-eye display waveguide device according to the embodiment of the present invention breaks through the limitation of the refractive index of the waveguide substrate on the angle spectrum range of the transmitted light beam.

In the near-eye display waveguide device according to the embodiment of the present invention, each color of light is transmitted through at least two waveguide substrates, and the corresponding coupling-in gratings have different grating periods, thereby greatly improving the field of view of the full-color display.

Returning to FIG. 3, each waveguide substrate W₁, W₂, W₃, and W₄(hereinafter also collectively referred to as “waveguide substrate W”) can be formed with a coupling-out grating g₁, g₂, g_{3,}and g₄ (hereinafter also collectively referred to as “coupling-out grating g”) and at least one coupling-in grating G as described above. FIG. 4 schematically shows an exemplary arrangement of the coupling-in grating G of the near-eye display waveguide device 100, wherein a plurality of waveguide substrates W stacked on each other and the coupling-in grating G and the coupling-out grating g formed thereon are shown in a manner that their projections on the top surface (located in the X-Y plane) of the waveguide device in a direction perpendicular to the waveguide substrates are stacked on each other on the left side of the top view of Graph (a), and the arrangement of the coupling-in gratings on the waveguide substrates W₁, W₂, W₃, and W₄ is shown in sequence from top to bottom on the right side; and Graph (b) further shows the arrangement of the coupling-in gratings in a side view observed along the X direction.

After being coupled into the waveguide substrate through the corresponding coupling-in grating, the image-carrying light of each dominant wavelength propagates to the coupling-out grating of the waveguide substrate through a total reflection path corresponding to the coupling-in grating. For example, in the near-eye display waveguide device 100 shown in FIG. 4, the image-carrying light of the dominant wavelength λ₂ is coupled into the waveguide substrate W₂ through the coupling-in grating G_{(2,1)} and then propagated to the coupling-out grating g₂ on the waveguide substrate W₂ through a total reflection path t; the situation is the same for other coupling-in gratings G and will not be described here. For the sake of clarity and simplicity, FIG. 4 only shows the total reflection path t corresponding to the coupling-in grating G₂. Advantageously, the total reflection path corresponding to the coupling-in grating for coupling in light of one dominant wavelength does not pass through the coupling-in grating for coupling in light of another dominant wavelength. This helps to avoid the loss of reflection efficiency caused by the light propagating along the total reflection path passing through the grating area. In the near-eye display waveguide device 100, from the projection in the direction perpendicular to the waveguide substrate (Z direction), the total reflection path t corresponding to the coupling-in grating G₂ for the dominant wavelength λ₂ does not pass through the coupling-in grating G₁ for the dominant wavelength λ₁ and the coupling-in grating G₃ for the dominant wavelength λ₃; the situation is the same for the total reflection paths of the coupling gratings G₁ and G₃, as shown in Graph (a) in FIG. 4.

According to embodiments of the present disclosure, optionally, the projections of the coupling-in gratings for coupling light of the same dominant wavelength formed on different waveguide substrates in a direction perpendicular to the waveguide substrate overlap each other. In this way, the light of the dominant wavelength with an image field of view angle range θ₀ from the same light engin LE can be sequentially irradiated onto the coupling-in gratings with different coupling field of view angle ranges θ₁ and θ₂, thereby simplifying the light engin configuration and improving the efficiency of light utilization. Advantageously, the coupling-in gratings for the same dominant wavelength can be formed on adjacent waveguide substrates.

For example, in the example shown in FIG. 4, the coupling-in grating G_{(1,1)} and the coupling-in grating G_{(1,2)} for the dominant wavelength λ₁ are respectively formed on adjacent waveguide substrates W₁ and W₂, and their projections in the Z direction perpendicular to the waveguide substrates overlap with each other, so that only a single projection of the coupling-in grating G₁ is shown in the left Graph (a) of FIG. 4; similarly, the coupling-in grating G_{(2,1)} and the coupling-in grating G_{(2,2)} for the dominant wavelength λ₂ are respectively formed on adjacent waveguide substrates W₂ and W₃, and their projections in the Z direction overlap with each other, so that only a single projection of the coupling-in grating G₂ is shown in the left Graph (a) of FIG. 4; the coupling-in grating G_{(3,1)} and the coupling-in grating G_{(3,2)} for the dominant wavelength λ₃ are respectively formed on adjacent waveguide substrates W₃ and W₄, and their projections in the Z direction overlap with each other, so that only a single projection of the coupling-in grating G₃ is shown in the left Graph (a) of FIG. 4.

According to embodiments of the present disclosure, optionally, the coupling-in gratings formed on the plurality of waveguide substrates have the same grating vector direction; and the coupling-in gratings formed on the plurality of waveguide substrates for coupling light of different dominant wavelengths are separated from each other in a direction parallel to each of the waveguide substrates and perpendicular to the grating vector direction. Since in the diffraction light waveguide, the light coupled into the waveguide substrate via the coupling-in grating propagates toward the coupling-out grating substantially along the grating vector direction of the coupling-in grating, this structure is conducive to avoiding the loss of reflection efficiency caused by the light passing through the grating area during the propagation from the coupling-in grating to the coupling-out grating, and even causing problems such as image ghosting.

For example, as shown in FIG. 4, each coupling-in grating G formed on the waveguide substrates W₁, W₂, W₃, and W₄ has the same grating vector direction (X direction shown in FIG. 4), and the coupling-in gratings G₁, G₂, G₃ formed on the waveguide substrates W₁, W₂, W₃, and W₄, which are used to couple the light of different dominant wavelengths λ₁, λ₂, and λ₃ are separated from each other in the Y direction.

Advantageously, a through hole can be formed on a waveguide substrate at a position perpendicular to the waveguide substrate facing the coupling-in grating on the waveguide substrate below it, so that the image-carrying light passes through. This is conducive to reducing light loss.

In addition, according to embodiments of the present invention, the coupling-in gratings formed on the same waveguide substrate can have the same grating vector direction and grating period and can be set at substantially the same orientation relative to the coupling-out grating on the waveguide substrate. In this way, it is conducive to simplifying the grating design and the configuration of the light engin used in conjunction with the waveguide device.

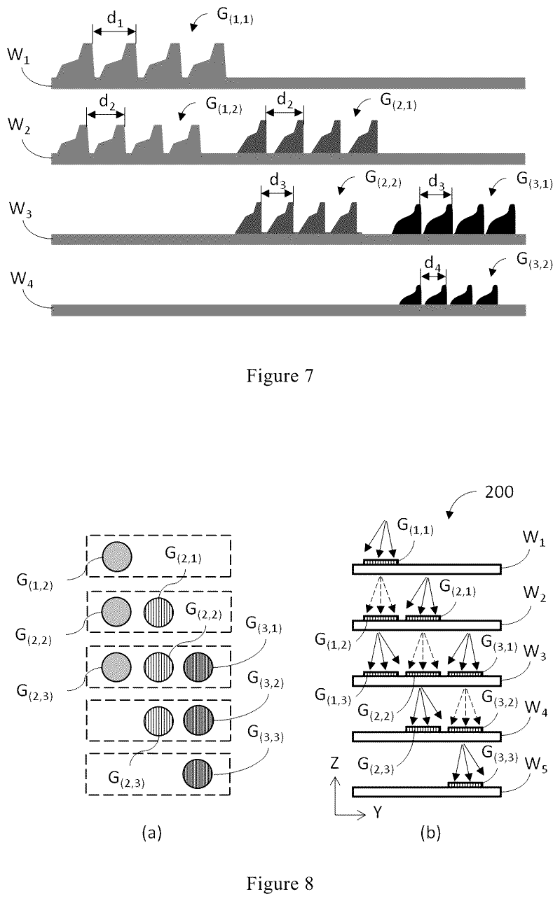

For example, as shown in FIG. 4, each coupling-in grating G formed on the waveguide substrates W₁, W₂, W₃, and W₄ can have the same grating vector direction (the X direction shown in FIG. 4) and are located upstream along the X direction relative to the coupling-out grating g, and the coupling-in grating G formed on the waveguide substrates W₁, W₂, W₃, and W₄ can have grating periods d₁, d₂, d₃ and d₄, respectively (see FIG. 7). In particular, the coupling-in gratings G_{(1,2)} and G_{(2,1)} formed on the waveguide substrate W₂ have the same grating period d₂; the coupling-in gratings G_{(2,2)} and G_{(3,1)} formed on the waveguide substrate W₃ have the same grating period d₃.

In the near-eye display waveguide device 100, preferably, in the case of the dominant wavelength λ₁>λ₂>λ₃, the grating period satisfies d₁>d₂>d₃>d₄. In addition, each waveguide substrate is preferably made of a material with the same or similar refractive index. In some cases, this can be achieved by using the same material to make each waveguide substrate. More preferably, λ₁/d₁, λ₂/d₂, and λ₃/d₃ are approximately equal and approximately a constant C₁, and/or λ₁/d₂, λ₂/d₃, and λ₃/d₄ are approximately equal and approximately a constant C₂, with a deviation of within ±5%, more preferably within ±1%. This allows substantially the same field of view boundary to be provided for the light of different dominant wavelengths, thereby maximizing the use of the available annular wave vector space limited by the refractive index of the waveguide substrate and greatly simplifying the design of the near-eye display waveguide device.

In addition, FIG. 7 schematically shows an example of grating structures of the coupling-in gratings of the near-eye display device 100. According to the embodiment of the present disclosure, advantageously, the coupling-in gratings formed on the same waveguide substrate for coupling light of different dominant wavelengths have different grating structure features. Here, the grating structure features comprise one or more of the depth, height, duty cycle, blaze angle, and optical coating of the gratings. For example, as shown in FIG. 7, the coupling-in gratings G_{(1,2)} and G_{(2,1)} formed on the waveguide substrate W₂ have different grating structure features; and the coupling-in gratings G_{(2,2)} and G_{(3,1)} formed on the waveguide substrate W₃ have different grating structure features. This is conducive to adjusting the diffraction efficiency of the coupling-in grating for different dominant wavelengths to improve light utilization efficiency and the uniformity of display brightness.

According to a preferred embodiment of the present disclosure, under the condition that λ₁/d₁, λ₂/d₂, and λ₃/d₃ are approximately equal and approximately a constant C₁, and λ₁/d₂, λ₂/d₃, and λ₃/d₄ are approximately equal and approximately a constant C₂, the coupling-in gratings formed on different waveguide substrates for the same dominant wavelength can have a grating structure that is proportional to its grating period. As an example only and not a limitation, as shown in FIG. 7, the grating structure of the coupling-in grating G_{(1,1)} and the grating structure of the coupling-in grating G_{(1,2)} can have similar cross-sections (for example, have the same or similar duty cycle, blaze angle), and the ratio between their sizes (for example, the depth and height of the grating) can be approximately the ratio between the grating periods d₁ and d₂; the relationship between the grating structures of the coupling-in grating G_{(2,1)} and the coupling-in grating G_{(2,2)} and the relationship between the grating structures of the coupling-in grating G_{(3,1)} and the coupling-in grating G_{(3,2)} are the same as the relationship between the grating structures of the coupling-in grating G_{(1,1)} and the coupling-in grating G_{(1,2)} described above, and will not be repeated here. Such a near-eye display waveguide device can not only expand the field of view angle range, optimize the diffraction efficiency, and improve the color uniformity, but also greatly simplify the grating design.

An example of the near-eye display waveguide device according to the embodiment of the present disclosure is introduced above with reference to FIGS. 3 to 7, namely, the near-eye display waveguide device 100, which comprises four waveguide substrates stacked on each other for receiving image-carrying light comprising three dominant wavelengths to achieve a large field of view and color display. However, it should be understood that the number of the above waveguide substrates and the number of dominant wavelengths are only exemplary and not restrictive.

For ease of understanding, FIG. 8 schematically shows another example of a near-eye display waveguide device according to embodiments of the present disclosure (a near-eye display waveguide device 200) and the arrangement of its coupling-in gratings. The near-eye display waveguide device 200 comprises five waveguide substrates W₁, W₂, W₃, W₄, and W₅ stacked on each other for receiving image-carrying light comprising three dominant wavelengths λ₁, λ₂, and λ₃ and performing near-eye image display. Similar to the near-eye display waveguide device 100, each waveguide substrate of the near-eye display waveguide device 200 can be formed with a coupling-out grating and at least one coupling-in grating (see FIG. 3). For the sake of simplicity, a top view of the waveguide device 200 is not shown in FIG. 8. Graph (a) in FIG. 8 shows the arrangement of each coupling-in gratings on the waveguide substrates W₁, W₂, W₃, W₄, and W₅ in order from top to bottom in a top view; and Graph (b) in FIG. 8 shows the arrangement of the coupling-in gratings in a side view observed along the X direction (the same grating vector direction of each coupling-in grating).

As shown in FIG. 8, the coupling-in gratings G_{(1,1)}, G_{(1,2)}, and G_{(1,3)} for the dominant wavelength λ₁ are respectively formed on adjacent waveguide substrates W₁, W₂, and W₃, and their projections in the Z direction perpendicular to the waveguide substrates overlap with each other; similarly, the coupling-in gratings G_{(2,1)}, G_{(2,2)}, and G_{(2,3)} for the dominant wavelength λ₂ are respectively formed on adjacent waveguide substrates W₂, W₃, and W₄, and their projections in the Z direction overlap with each other; the coupling-in gratings G_{(3,1)}, G_{(3,2)}, and G_{(3,3)} for the dominant wavelength λ₃ are respectively formed on adjacent waveguide substrates W₃, W₄, and W₅, and their projections in the Z direction overlap with each other.

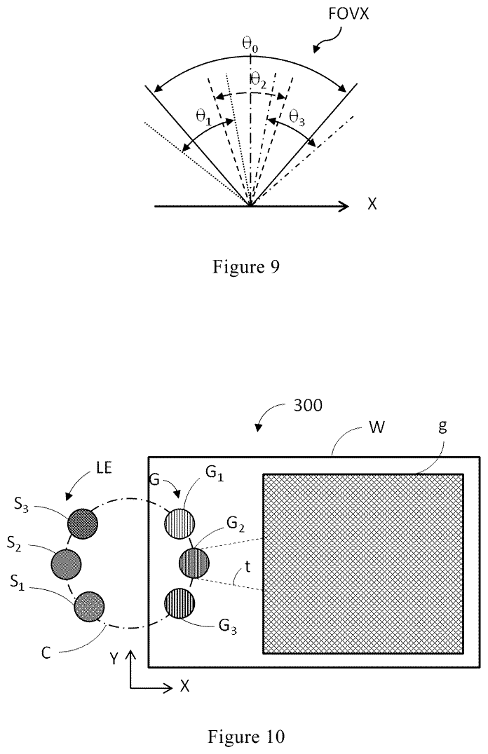

FIG. 9 schematically shows an exemplary relationship between the coupling-in field of view angle range of three coupling-in gratings for the same dominant wavelength in a near-eye display waveguide device according to other embodiments of the present disclosure and the image field of view angle range of the image carrying light projected by a light engin. The near-eye display waveguide device 200 shown in FIG. 8 is configured such that the coupling-in field of view angle ranges θ₁, θ₂, θ₃ of the three coupling-in gratings (for example, coupling-in gratings G_{(1,1)}, G_{(1,2)}, G_{(1,3)}) for the same dominant wavelength and the image field of view angle range θ₀ of the image-carrying light projected by the light engin conform to the relationship shown in FIG. 9, that is, the coupling-in field of view angle ranges θ₁, θ₂, θ₃ are each smaller than the image field of view angle range θ₀, but cover the image field of view angle range θ₀ as a whole.

The near-eye display waveguide device 200 can have other features of the near-eye display waveguide device 100 described above with reference to FIGS. 3 to 7, which will not be described in detail here.

It can be seen that the number of waveguide substrates and dominant wavelengths in the near-eye display waveguide device according to the embodiment of the present disclosure can have various different situations. In summary, the m (m>3) waveguide substrates of the near-eye display waveguide device according to the embodiment of the present disclosure are waveguide substrates Wᵢ, i is an integer and 1≤i≤m, wherein:
(1) for i=1, a coupling-in grating G_{(1,1)} for the dominant wavelength λ₁ is formed on a waveguide substrate W₁, and the coupling-in grating G_{(1,1)} has a grating period d₁;
(2) for i=m, a coupling-in grating G_{(m-1,2)} for the dominant wavelength λₘ₋₁ is formed on a waveguide substrate Wₘ, and the coupling-in grating G_{(m-1,2)} has a grating period dₘ; and
(3) for 2≤i≤m−1, a coupling-in grating G_{(i,1)} for the dominant wavelength λᵢ and a coupling-in grating G_{(i-1,2)} for the dominant wavelength λᵢ₋₁ are formed on the waveguide substrate Wi, and satisfy: λᵢ₋₁>λⱼ>λⱼ₊₁.

It should be understood that although only two coupling-in gratings for the same dominant wavelength formed on two waveguide substrates are described above, this does not exclude that more coupling-in gratings for the dominant wavelength can be formed on one or more other waveguide substrates. As an example, reference can be made to the near-eye display waveguide device 200 described above with reference to FIG. 8.

Preferably, for 2≤i≤m−1, the coupling-in grating G_{(i,1)} and the coupling-in grating G_{(i-1,2)} have the same grating vector direction and grating period dᵢ, and dᵢ₋₁>dᵢ>dᵢ₊₁.

Preferably, for 1≤i≤m−1, it satisfies: λᵢ/dᵢ is approximately a constant C₁, and/or λᵢ/dᵢ₊₁ is approximately a constant C₂, wherein a deviation is within ±5%.

FIG. 10 is a top view of another example of a near-eye display waveguide device according to embodiments of the present disclosure, wherein a plurality of waveguide substrates W stacked on each other in the near-eye display waveguide device and coupling-in gratings G and a coupling-out grating g formed thereon are shown in a manner that their projections on the top surface (located in the X-Y plane) of the waveguide device in a direction perpendicular to the waveguide substrate (Z direction) are stacked on each other.

A near-eye display waveguide device 300 shown in FIG. 10 has a configuration substantially the same as the near-eye display waveguide device 100 described above with reference to FIGS. 3 to 7, except that: in the near-eye display waveguide device 100, the coupling-in gratings G₁, G₂, G₃ for different dominant wavelengths λ₁, λ₂, λ₃ are arranged in a straight line perpendicular to their common grating vector direction (X direction), while in the near-eye display waveguide device 300, the coupling-in gratings G₁, G₂, G₃ are arranged on a circular circumference C, which is determined by the positions of light sources S₁, S₂, S₃ for projecting the dominant wavelengths λ₁, λ₂, λ₃ in a reflective light engin LE to be used in combination with the near-eye display waveguide device 300. In other words, the coupling-in gratings G₁, G₂, G₃ and the light sources S₁, S₂, and S₃ are arranged on the same circumference.

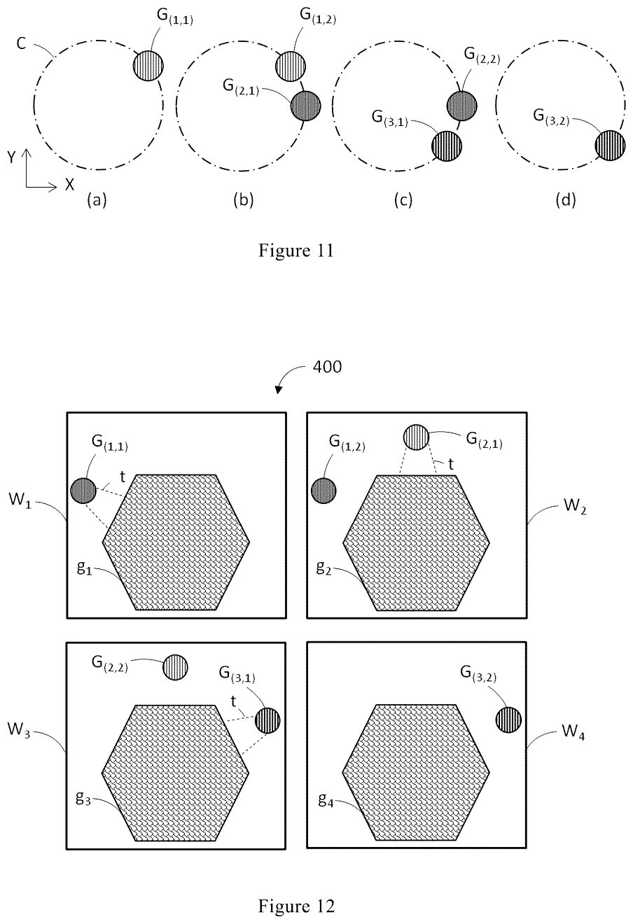

FIG. 11 schematically shows an exemplary arrangement of coupling-in gratings in the near-eye display waveguide device 300, wherein Graph (a), (b), (c), and (d) respectively show the arrangement of the respective coupling-in gratings on the waveguide substrates W₁, W₂, W₃, and W₄.

The near-eye display waveguide device 300 can have other features similar to those of the near-eye display waveguide device 100 described above with reference to FIGS. 3 to 7, which will not be described in detail herein.

It should be understood that the near-eye display waveguide device 300 shown in FIG. 10 can also be constructed to have a configuration substantially the same as the near-eye display waveguide device 200 described above with reference to FIGS. 8 and 9, which will not be described in detail herein.

In the examples of the near-eye display waveguide device according to the embodiments of the present disclosure described above with reference to FIGS. 3 to 11, the coupling-in gratings G have the same grating vector direction (X direction). However, it should be understood that the present invention is not limited in this respect. That is, according to some other embodiments of the present invention, the coupling-in gratings in the near-eye display waveguide device can have different grating vector directions.

For ease of understanding, FIG. 12 shows a top view of yet another example of a near-eye display waveguide device according to embodiments of the present disclosure. A near-eye display waveguide device 400 shown in FIG. 12 comprises four waveguide substrates W₁, W₂, W₃, and W₄ stacked on each other, which receive image-carrying light comprising three dominant wavelengths λ₁, λ₂, and λ₃, and expand the pupil through the corresponding coupling-out gratings g₁, g₂, g₃, and g₄ formed thereon and couple the light out of the waveguide substrate to realize image display, wherein the waveguide substrate W₁ is formed with a coupling-in grating G_{(1,1)} for the dominant wavelength λ₁; the waveguide substrate W₂ is formed with a coupling-in grating G_{(2,1)} for the dominant wavelength λ₂ and a coupling-in grating G_{(1,2)} for the dominant wavelength λ₁; the waveguide substrate W₃ is formed with a coupling-in grating G_{(3,1)} for the dominant wavelength λ₃ and a coupling-in grating G_{(2,2)} for the dominant wavelength λ₂; the waveguide substrate W₄ is formed with a coupling-in grating G_{(3,2)} for the dominant wavelength λ₃.

In order to propagate the light coupled into the waveguide substrate from the coupling-in grating to the coupling-out grating, in the near-eye display waveguide device 400 shown in FIG. 12, the coupling-in gratings G_{(1,1)} and G_{(1,2)} for the dominant wavelength λ₁ have a grating vector direction pointing from the upper left to the coupling-out grating g₁, the coupling-in gratings G_{(2,1)} and G_{(2,2)} for the dominant wavelength λ₂ have a grating vector direction pointing from the upper right to the coupling-out grating g₂, and the coupling-in gratings G_{(3,1)} and G_{(3,2)} for the dominant wavelength λ₁ have a grating vector direction pointing from the upper right to the coupling-out grating g₃. It can be seen that the coupling-in gratings for different dominant wavelengths in the near-eye display waveguide device 400 have different grating vector directions. From the perspective of a single waveguide substrate, according to some embodiments of the present disclosure, the coupling-in gratings formed on the same waveguide substrate can have different grating vector directions and can be set at different orientations relative to the coupling-out gratings on the waveguide substrate.

In addition to the features regarding the grating vector direction of the coupling-in grating described above with reference to FIG. 12, the near-eye display waveguide device 400 can have other features similar to the near-eye display waveguide devices 100 and 200 described above with reference to FIGS. 3 to 9, which will not be described in detail herein.

The technical effect of the near-eye display waveguide device according to the embodiment of the present disclosure will be described below through data examples.

In the following data examples, the field of view angle is represented by (FOVX, FOVY), where the field of view angle FOVX is the angle formed by the incident light relative to the normal line (Z axis, see FIGS. 3 and 8) of the X-Y plane (see FIG. 1) where the coupling-in grating is located in the direction around the Y axis, and the field of view angle FOVY is the angle formed by the incident light relative to the normal line in the direction around the X axis, and the X axis is the direction parallel to the grating vector of the coupling-in grating.

### Data Example 1

A near-eye display waveguide device used in Data Example 1 has the structure of the near-eye display waveguide device 100 shown in FIGS. 3 and 4 and is used to cooperate with a light engin that projects image-carrying light with dominant wavelengths λ₁=624 nm (red light), λ₂=522 nm (green light), and λ₃=455 nm (blue light). The image field of view angle range of the image-carrying light projected by the light engin is θ₀, θ₀=(−26:26°, −15:15°).

In the near-eye display waveguide device of Data Example 1:
(1) The waveguide substrates W₁, W₂, W₃, and W4 are made of the same glass material and have substantially the same refractive index n=1.7 for the dominant wavelengths λ₁, λ₂, and λ₃.
(2) The coupling-in grating G_{(1,1)} on the waveguide substrate W₁ is used to couple in red light with a dominant wavelength λ₁=624 nm and has a grating period d₁=508 nm.
(3) The coupling-in gratings G_{(1,2)} and G_{(2,1)} on the waveguide substrate W₂ are used to couple in red light with a dominant wavelength λ₁=624 nm and green light with a dominant wavelength λ₂=522 nm, respectively. They have the same grating period d₂=425 nm and are arranged at intervals in the Y direction, and the projections of the coupling-in gratings G_{(1,1)} and G_{(1,2)} in the Z direction substantially overlap.
(4) The coupling-in gratings G_{(2,2)} and G_{(3,1)} on the waveguide substrate W₃ are used to couple in green light with a dominant wavelength λ₂=522 nm and blue light with a dominant wavelength λ₃=455 nm, respectively. They have the same grating period d₃=370 nm and are arranged at intervals in the Y direction, and the projections of the coupling-in grating G_{(2,1)} and the coupling-in grating G_{(2,2)} in the Z direction substantially overlap.
(5) The coupling-in grating G_{(2,2)} on the waveguide substrate W₄ is used to couple in blue light with a dominant wavelength of λ₃=455 nm and has a period d₄=322 nm, and the projections of the coupling-in grating G_{(3,1)} and the coupling-in grating G_{(3,2)} in the Z direction substantially overlap.
(6) The image-carrying light is incident from one side of the waveguide substrate W₄, and the coupling-in gratings G are all located on the side of the corresponding waveguide substrates opposite to the incident side of the image-carrying light.

Based on the above parameters, the coupling-in field of view angle range of each coupling-in grating is calculated according to the light beam wave vector space as follows:
the coupling-in grating G_{(1,1)} has an available field of view angle range θᵣ₁=(−13:27°, −16:16°);
the coupling-in grating G_{(1,2)} has an available field of view angle range θᵣ₂=(−28:13°, −16:16°);
the coupling-in grating G_{(2,1)} has an available field of view angle range θ_{g1}=(−13:27°, −16:16°);
the coupling-in grating G _{(2,2)} has an available field of view angle range θ_{g2}=(−28:13°, −16:16°);
the coupling-in grating G_{(3,1)} has an available field of view angle range θb1=(−13:27°, −16:16°); and
the coupling-in grating G_{(3,2)} has an available field of view angle range θ_{b2}=(−28:13°, −16:16°).

It can be seen that the coupling-in field of view angle ranges θᵣ₁, θᵣ₂, θ_{g1}, 0θ₂, θ_{b1}, and θ_{b2} of the coupling-in grating in the near-eye display waveguide of data example 1 are each smaller than the image field of view angle range θ₀. However, the coupling-in field of view angle ranges θᵣ₁+θᵣ₂, θ_{g1}+θ_{g2}, θ_{b1}+θ_{b2} of the coupling-in grating for the same dominant wavelength can cover the image field of view angle range θ₀ as a whole.

By designing the diffraction efficiency curve of the coupling-in grating, each coupling-in grating G can be used to couple the image-carrying light within the following field of view angle ranges:
the coupling-in gratings G_{(1,1)}, G_{(2,1)}, and G_{(3,1)} are used to couple in the red light, green light, and blue light within the field of view angle range θ₁=(−12:26°, −15:15°);
the coupling gratings G_{(1,2)}, G_{(2,2)}, and G_{(3,2)} are used to couple in the red light, green light, and blue light within the field of view angle range θ₂=(−26:12°, −15:15°).

That is, the near-eye display waveguide device of Data Example 1 can support the coupling-in and total reflection transmission of full-color white light within the field of view angle range of 52°×30°, and the diagonal viewing angle reaches 58°.

In addition, in the near-eye display waveguide device of Data Example 1: λ₁/d₁=1.228, λ₂/d₂=1.228, λ₃/d₃=1.230, which are approximately a constant 1.228, and the deviation is within 1%; λ₁/d₂=1.468, λ₂/d₃=1.411, λ₃/d₄=1.403, which are approximately a constant 1.411, and the deviation is within 5%.

When the refractive index of each waveguide substrate is basically the same and the ratio of wavelength to grating period is approximately constant, the diffraction efficiency of each coupling-in grating is very close; on this basis, by controlling the grating structure parameters of each waveguide substrate, such as depth, duty cycle, coating, etc., further fine-tuning and optimization are performed, and finally an output result with high color uniformity is obtained, where the color deviation value Δu′v′<0.03. The color deviation value of the traditional design method is about 0.1. The color deviation value is defined as the maximum color difference between any two points in the CIE1976 (u′, v′) color coordinate space. The smaller the value, the higher the color uniformity. The expression of the color deviation value Δu′v′ is as follows:

$$Δ {u}^{′} {v}^{′} = max ( \sqrt{{( {u}_{i}^{′} - {u}_{j}^{′} )}^{2} + {( {v}_{i}^{′} - {v}_{j}^{′} )}^{2}} )$$

wherein (u′ᵢ, v′ᵢ), (u′ⱼ, v′ⱼ) are the color coordinates of the i, j field of view areas of the output result, i, j=1, 2 . . . n, where n is the total number of divided filed of view areas of the output result.

### Data Example 2

A near-eye display waveguide device used in Data Example 2 has the structure of the near-eye display waveguide device 300 shown in FIGS. 10 and 11 and is used to cooperate with an off-axis light engin. The light engin projects image-carrying light with dominant wavelengths λ₁=622 nm (red light), λ₂=532 nm (green light), and λ₃=455nm (blue light), and the image field of view angle range of the image-carrying light is θ₀=(−35:35°, −22:22°).

In the near-eye display waveguide device of Data Example 2:
(1) The waveguide substrates W₁, W₂, W₃, and W4 are made of the same glass material and have refractive indices n₁=1.93, n₂=1.96, and n₃=2.00 for the dominant wavelengths λι, λ₂, and λ₃ respectively.
(2) The coupling-in grating G_{(1,1)} on the waveguide substrate W₁ is used to couple in red light with a dominant wavelength λ₁=622 nm and has a grating period d₁=462 nm.
(3) The coupling-in gratings G_{(1,2)} and G_{(2,1)} on the waveguide substrate W₂ are used to couple in red light with a dominant wavelength λ₁=622 nm and green light with a dominant wavelength λ₂=532 nm, respectively. They have the same grating period d₂=395 nm and are arranged at intervals in the Y direction, and the projections of the coupling-in gratings G_{(1,1)} and G_{(1,2)} in the Z direction substantially overlap.
(4) The coupling-in gratings G_{(2,2)} and G_{(3,1)} on the waveguide substrate W₃ are used to couple in green light with a dominant wavelength λ₂=532 nm and blue light with a dominant wavelength λ₃=455 nm, respectively. They have the same grating period d₃=338 nm and are arranged at intervals in the Y direction, and the projections of the coupling-in grating G_{(2,1)} and the coupling-in grating G_{(2,2)} in the Z direction substantially overlap.
(5) The coupling-in grating G_{(2,2)} on the waveguide substrate W₄ is used to couple in blue light with a dominant wavelength of λ₃=455 nm and has a period d₄=289 nm, and the projections of the coupling-in gratings G_{(3,1)} and G_{(3,2)} in the Z direction substantially overlap.
(6) The projections of the coupling-in gratings G in the Z direction perpendicular to the waveguide substrate W are arranged on a circle, so that they are symmetrical with the red, green and blue light sources of the off-axis light engin about the center of the circle.
(7) The image-carrying light is incident from one side of the waveguide substrate W₁, and the coupling-in gratings G are all located on the image-carrying light incident side of the corresponding waveguide substrate.

Based on the above parameters, the coupling-in field of view angle range of each coupling-in grating is calculated according to the light beam wave vector space as follows:
the coupling-in grating G_{(1,1)} has an available field of view angle range θᵣ₁=(−20:36°, −26:26°);
the coupling-in grating G_{(1,2)} has an available field of view angle range θᵣ₂=(−35:20°, −26:26°);
the coupling-in grating G_{(2,1)} has an available field of view angle range θ_{g1}=(−20:38°, −27:27°);
the coupling-in grating G_{(2,2)} has an available field of view angle range θ_{g2}=(−35:22°, −27:27°);
the coupling-in grating G_{(3,1)} has an available field of view angle range θ_{b1}=(−20:40°, −28:28°);
the coupling-in grating G_{(3,2)} has an available field of view angle range θ_{b2}=(−35:24°, −28:28°).

It can be seen that the coupling-in field of view angle ranges θᵣ₁, θᵣ₂, θ_{g1}, θ_{g2}, θ_{b1}, and θ_{b2} of the coupling-in grating in the near-eye display waveguide of data example 2 are each smaller than the image field of view angle range θ₀. However, the coupling-in field of view angle ranges θᵣ₁+θᵣ₂, θ_{g1}+θ_{g2}, θ_{b1}+θ_{b2} of the coupling-in grating for the same dominant wavelength can cover the image field of view angle range θ₀ as a whole.

By designing the diffraction efficiency curve of the coupling-in grating, each coupling-in grating G can be used to couple the image-carrying light within the following field of view angle ranges:
the coupling-in gratings G_{(1,1)}, G_{(2,1)}, and G_{(3,1)} are used to couple in the red light, green light, and blue light within the field of view angle range θ₁=(−18:35°, −22:22°);
the coupling-in gratings G_{(1,2)}, G_{(2,2)}, and G_{(3,2)} are used to couple in the red light, green light, and blue light within the field of view angle range θ₂=(−35:18°, −22:22°).

That is, the near-eye display waveguide device of Data Example 2 can support the coupling-in and total reflection transmission of full-color white light within the field of view angle range of 70°×44°, and the diagonal viewing angle reaches 80°.

In addition, in the near-eye display waveguide device of Data Example 2:
λ₁/d₁=1.346, λ₂/d₂=1.347, λ₃/d₃=1.346, which are approximately a constant 1.346, and the deviation is within 1%; λ₁/d₂=1.575, λ₂/d₃=1.574, λ₃/d₄=1.574, which are approximately a constant 1.574, and the deviation is within 1%.

When the refractive index of each waveguide substrate is basically the same and the ratio of wavelength to grating period is approximately constant, the diffraction efficiency of each coupling-in grating is very close; on this basis, by controlling the grating structure parameters of each waveguide substrate, such as depth, duty cycle, coating, etc., further fine-tuning and optimization are performed, and finally an output result with high color uniformity is obtained, where the color deviation value Δu′v′<0.03. The color deviation value of the traditional design method is about 0.15.

The near-eye display waveguide device according to embodiments of the present disclosure can be applied to a near-eye display apparatus. Such a near-eye display apparatus comprises a lens and a frame for holding the lens close to the eye, wherein the lens can comprise the near-eye display waveguide device according to embodiments of the present disclosure as described above. Preferably, the display apparatus is an augmented reality display apparatus or a virtual reality display apparatus.

The above description is merely an illustration of the preferred embodiments of the present application and the applied technical principles. Those skilled in the art should understand that the scope of the disclosure involved in the present application is not limited to the technical solution formed by the specific combination of the above technical features, but also covers other technical solutions formed by any combination of the above technical features or their equivalent features without departing from the inventive concept. For example, the technical solution is formed by replacing the above features with (but not limited to) the technical features with similar functions disclosed in the present application.

What is claimed is:

1. A near-eye display waveguide device, comprising m waveguide substrates stacked on each other, m being an integer and m>3, the near-eye display waveguide device receiving image-carrying light with an image field of view angle range, and the image-carrying light comprising light of less than m dominant wavelengths, wherein:
corresponding to each dominant wavelength, the m waveguide substrates are formed with at least two coupling-in gratings, the at least two coupling-in gratings are formed on different waveguide substrates and have different grating periods, for being used to couple light in different coupling-in field of view angle ranges into the corresponding waveguide substrates, wherein the coupling-in field of view angle ranges are each smaller than the image field of view angle range, and the coupling-in field of view angle ranges as a whole cover the image field of view angle range;
the m waveguide substrates are waveguide substrates Wᵢ, i is an integer and 1≤i≤m, wherein,
for i=1, a coupling-in grating G_{(1,1)} for a dominant wavelength λ₁ is formed on a waveguide substrate W₁, and the coupling-in grating G_{(1,1)} has a grating period d₁;
for i=m, a coupling-in grating G_{(m-1,2)} for a dominant wavelength λₘ₋₁ is formed on a waveguide substrate Wₘ, and the coupling-in grating G_{(m-1,2)} has a grating period dₘ;
for 2≤i≤m−1, a coupling-in grating G_{(i,1)} for a dominant wavelength λᵢ and a coupling-in grating G_{(i-1,2)} for the dominant wavelength λᵢ₋₁ are formed on the waveguide substrate Wᵢ, and satisfy: λᵢ₋₁>λᵢ>λᵢ₊₁,
wherein, for 2≤i≤m−1, the coupling-in grating G_{(i,1)} and the coupling-in grating G_{(i-1,2 )}have the same grating vector direction and grating period dᵢ, and dᵢ₋₁>dᵢ>dᵢ₊₁, and
wherein, for 1≤i≤m−1: λᵢ/dᵢ is approximately a constant C₁, and/or λᵢ/dᵢ₊₁ is approximately a constant C₂, wherein a deviation is within ±5%.

2. The near-eye display waveguide device of claim 1, wherein each waveguide substrate is formed with a coupling-out grating and at least one coupling-in grating;
after being coupled into a waveguide substrate through a corresponding coupling-in grating, the image-carrying light of each dominant wavelength propagates to the coupling-out grating of the waveguide substrate through a total reflection path corresponding to the coupling-in grating; and
the total reflection path corresponding to a coupling-in grating for coupling light of one dominant wavelength does not pass through a coupling-in grating for coupling light of another dominant wavelength.

3. The near-eye display waveguide device of claim 1, wherein the coupling-in gratings formed on the m waveguide substrates have the same grating vector direction; and
the coupling-in gratings formed on the m waveguide substrates for coupling light of different dominant wavelengths are separated from each other in a direction parallel to each waveguide substrate and perpendicular to the grating vector direction.

4. The near-eye display waveguide device of claim 1, wherein the coupling-in gratings formed on the same waveguide substrate have the same grating vector direction and grating period and are arranged at substantially the same orientation relative to the coupling-out gratings on the waveguide substrate; or the coupling-in gratings formed on the same waveguide substrate have different grating vector directions and/or grating periods and are arranged at different orientations relative to the coupling-out gratings on the waveguide substrate.

5. The near-eye display waveguide device of claim 4, wherein the coupling-in gratings formed on the same waveguide substrate for coupling light of different dominant wavelengths have different grating structure features, and the grating structure features comprise one or more of depth, height, duty cycle, blaze angle, and optical coating of the gratings.

6. The near-eye display waveguide device of claim 1, wherein the projections of the at least two coupling-in gratings formed on different waveguide substrates for coupling light of the same dominant wavelength overlap each other in a direction perpendicular to the waveguide substrate.

7. The near-eye display waveguide device of claim 6, wherein at least two coupling-in gratings are formed on adjacent waveguide substrates.

8. The near-eye display waveguide device of claim 1, wherein m=4, and the image-carrying light comprises red, green, and blue light.

9. The near-eye display waveguide device of claim 1, wherein the m waveguide substrates are made of materials with the same or similar refractive index.

10. The near-eye display waveguide device of claim 1, wherein, for 2≤i≤m−1, the coupling-in grating G_{(i,1)} and the coupling-in grating G_{(i-1,2)} have different grating structure features, and the grating structure features comprise one or more of depth, height, duty cycle, blaze angle and optical coating of the gratings.

11. The near-eye display waveguide device of claim 1, wherein, for 1≤i≤m−1, j is an integer and 1≤j≤m−1, k=1 or 2, and i≠j, a coupling-in grating G_{(i,k)} and a coupling-in grating G_{(j,k)} are separated from each other in a direction perpendicular to the waveguide substrates.

12. The near-eye display waveguide device of claim 1, wherein, for 1≤i≤m−1, the projections of the coupling-in grating G_{(i,1)} and the coupling-in grating G_{(i,2)} overlap each other in a direction perpendicular to the waveguide substrates.

13. The near-eye display waveguide device of claim 12, wherein the coupling-in grating G_{(i,1)} and the coupling-in grating G_{(i,2)} are formed on adjacent waveguide substrates.

14. A near-eye display apparatus, comprising the near-eye display waveguide device of claim 1.

15. The near-eye display apparatus of claim 14, wherein the near-eye display device further comprises a lens and a frame for holding the lens close to eye, and the lens comprises the near-eye display waveguide device.
